(19) United States
(12) Patent Application Publication
(10) Pub. No.: US 2004/0128875 A1
(43) Pub. Date: Jul. 8, 2004

(54) Promotional card with pull out tab

(76) Inventors: Diane DeAngelus, New York, NY (US); Stewart Seidman, New York, NY (US)

Correspondence Address: Kaplan & Gilman, 900 Route 9 North, Woodbridge, NJ, 07095, US

(21) Appl. No.: 10/474,633

(22) PCT Filed: Apr. 10, 2001
(86) PCT No.: PCT/US01/11626

(51) Int. Cl. G09F 1/00

(52) U.S. Cl. 40/124.01

(57) ABSTRACT

There is disclosed a promotional card (1) which is made from a blank of sheet material (7), such as thin cardboard, that contains a promotional material, such as a fragrance sample, labels, a rub off, promotinal messages, a pull apart, or the like, and combination thereof. The card consists of a pouch (1) having an opening (3), a pulling tab (15) which is detachably secured to the pouch adjacent the opening and an insert tab (7) which extends from the pulling tab through the opening. In order to take note of the promotional material, the pulling tab is detached from the pouch, any promotional material present on the insert tab is noted, after which the insert tab is reinserted into the pouch through the opening to be used for another test. The blank used to make the fragrance card is also disclosed.

### BACKGROUND OF THE INVENTION

(a) Field of the Invention

The present invention relates to a promotional card with a pull out tab. More particularly, the invention is concerned with a disposable of the type to be distributed to potential customers for promotion purposes and which is easy and inexpensive to produce. The invention preferably concerns a fragrance card enabling a customer to test a particular fragrance.

(b) Description of Prior Art

It is standard practice to distribute sample bottles of perfume or other fragrance containing material so as to enable a potential client to check whether a particular perfume or fragrance would be of interest. Another way of sampling a fragrance is to spray it on a small piece of cardboard, enabling a customer to verify whether the odor would be of interest. Bottle samples are quite expensive to produce and take a lot of storage place. On the other hand, the spraying of a fragrance on a piece of cardboard causes the odor to spread in the surrounding area. In addition, if the customer places the piece of cardboard in a handbag for further testing, the smell becomes impregnated in the entire content of the handbag.

In addition, articles which are distributed to customers for promotional purposes take a variety of shapes and designs which increases the cost of advertising. To our knowledge, none of these articles are presented to customers with the same design whether they are intended to contain a fragrance, a rub off, promotional messages, or the like and combinations thereof.

It is therefore an object of the present invention to provide a promotional card with a pull out tab, that is cheap to produce and has none of the disadvantages of the sample bottles or the use of spraying on a piece of cardboard or the multiplicity of designs which are common to most promotional articles.

It is another object of the present invention to provide a fragrance card which is inexpensive to produce and which can be preserved without causing its fragrance to impregnate surrounding objects.

It is another object of the present invention to provide promotional articles which can contain either a fragrance, labels, rub off, promotional messages, or the like, or any combination thereof.

### SUMMARY OF INVENTION

The above and other objects of the present invention may be achieved by providing a promotional card with a pull out tab, that is made from a blank of sheet material to contain a promotional material such as a fragrance sample, a label, a rub off, promotional messages, a pull apart, or the like, or any combinations thereof. The promotional card comprises

a pouch having an opening;

a pulling tab detachably secured to the pouch adjacent the opening;

an insert tab extending from the pulling tab through the opening into the pouch;

promotional material placed on said insert tab;

so constructed and arranged that in order to take note of said promotional material, the pulling tab is detached from the pouch, the material on said insert tab is noted, after which the insert tab is reinserted into the pouch through the opening to be used for another test.

In accordance with a preferred embodiment, the pouch comprises a first sheet folded in half along a first folding line, half portions of the first sheet being sealed together along lateral edges thereof while allowing edges opposite the folding line to separate to constitute the opening. The first sheet is preferably rectangular, although any other suitable shape may be used as will be appreciated by one skilled in the art.

In accordance with another preferred embodiment the rectangular first sheet comprises strips of adhesive along the lateral edges of the half portions, the strips of adhesive being arranged to seal the rectangular sheet material into the pouch, the pouch then being provided with an opening.

In accordance with yet another preferred embodiment, at an end corresponding to the opening, the pouch comprises a rear shank portion and a front shank portion, the insert tab extending into the pouch between the rear shank portion and the front shank portion.

Preferably, the front shank portion has a recess formed therein to enable a person to pinch the pulling tab while pressing on the insert tab, thereby facilitating twisting and pulling of the pulling tab for taking note of the promotional material.

In accordance with yet another preferred embodiment, the pulling tab comprises a second sheet folded in half, the second sheet extending from the rear shank portion, and a score line detachably joining the second sheet to the rear shank portion. Preferably, half parts of the second sheet are sealed together by means of an adhesive. The promotional card is preferably made of glazed flexible cardboard although any other suitable material may be used, such as a sheet of an appropriate plastic material, as will be appreciated by one skilled in the art.

The invention also relates to a promotional card blank of sheet material comprising a first sheet divided into a first portion and a second portion of similar dimensions by means of a first folding line, a second sheet extending from the first sheet at an end of the second portion, and detachably connected thereto by means of a score line, the second sheet being divided into a first part and a second part of similar dimensions by means of a second folding line, and an insert tab extending from the second part at an end thereof.

The invention also relates to a process for manufacturing a promotional card which comprises providing a promotional card blank as defined above, applying promotional material on the insert tab, applying an adhesive on the first part and the second part, folding the second part including the fragrance finger at the second folding line over the first part, and causing the first part and the second part to adhesively adhere together, applying an adhesive along lateral edges of the first and second portions to form adhesive strips and folding the first portion over the second portion at the first folding line, to seal the first portion against the second portion under conditions to constitute a pouch containing the insert tab.

### BRIEF DESCRIPTION OF DRAWINGS

The invention will now be illustrated by means of preferred embodiment which is illustrated in the annexed drawings but is not limited thereto. In the drawings:

FIG. 1 is a perspective view of a promotional card according to the invention;

FIG. 2 is a perspective view of a promotional card illustrated in FIG. 1 showing how to detach the insert tab from the promotional card;

FIG. 3 is a perspective view showing the insert tab once removed from the promotional card;

FIG. 4 is a cross-section view taken along line 4-4 of FIG. 1;

FIG. 5 is a view of the blank used to produce the promotional card according to the invention;

FIG. 6 is a perspective view showing the folding of the blank illustrated in FIG. 5 into a promotional card according to the invention;

FIG. 7 is a partial view of a promotional card according to the invention wherein removable labels are placed on the insert tab;

FIG. 8 is a partial view of a promotional card according to the invention including a promotional message;

FIG. 9 is a partial view of a promotional card according to the invention wherein a pull apart is placed on the insert tab;

FIG. 10 is a partial view of a promotional card according to the invention wherein a rub off has been placed on the insert tab; and

FIG. 11 is a partial view of a promotional card according to the invention wherein a fragrance powder has been placed on the insert tab.

### DESCRIPTION OF PREFERRED EMBODIMENT

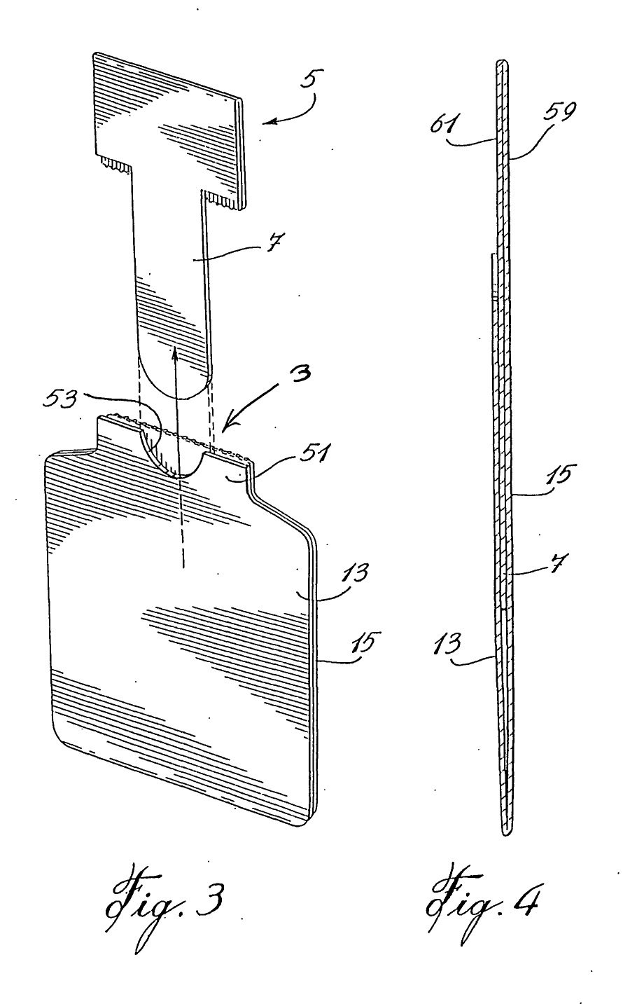

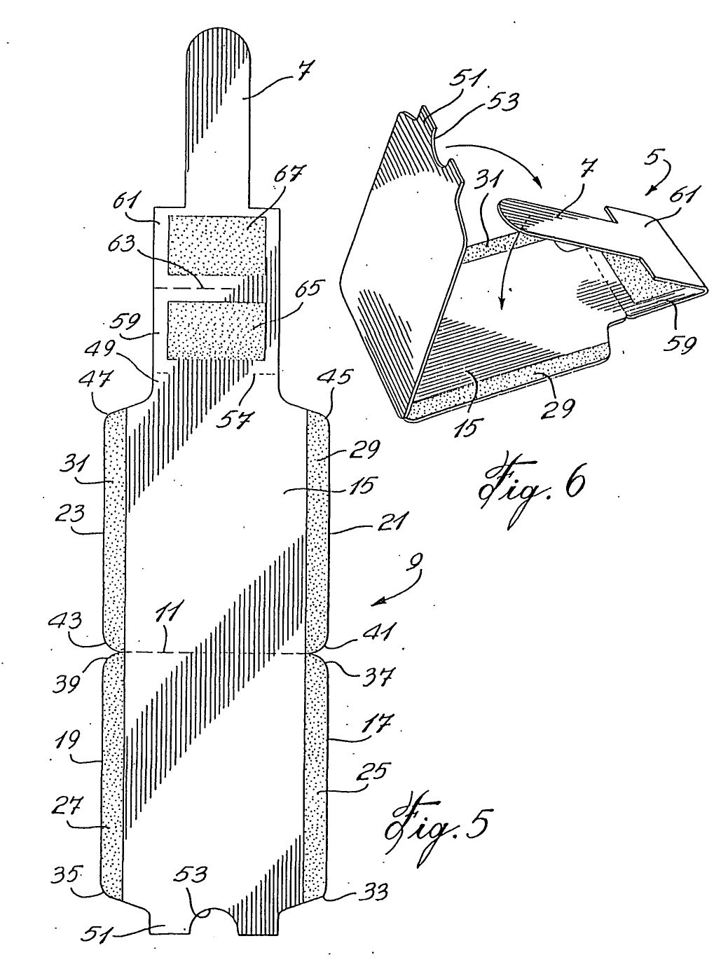

With reference to the drawings; it will be seen that the promotional card which is illustrated generally comprises a pouch 1 formed with an opening 3 (FIG. 3), a pulling tab 5 which is secured to pouch 1 in a manner that will be described later and an insert tab 7 which extends from pulling tab 5 as particularly shown in FIG. 3 of the drawings. In the illustrated embodiment, the promotional card is made of a thin sheet of glazed cardboard. Obviously, any other suitable material can be used, as will be appreciated by one skilled in the art.

With reference to pouch 1, the latter consists of a rectangular sheet 9 which is folded in half along folding line 11. To constitute pouch 1, it will be seen that rectangular sheet 9 is divided in half by means of folding line 11 to form front half portion 13 and rear half portion 15. Along lateral edges 17, 19 of front half portion 13 and lateral edges 21, 23 of rear half portion 15 there are provided four strips 25, 27, 29, 31 of an adhesive material. Of course the choice of a particular adhesive material is entirely left to one skilled in the art, depending on many factors, such as price, effectiveness in providing a good seal and the nature of the material on which the adhesive is applied. Once sealed together, front half portion 13 and rear half portion 15 will constitute pouch 1. Since no adhesive is provided at the ends of half portions 13 and 15, once these half portions are sealed by means of strips 25, 27, 29 and 31, free opening 3 will be formed as will be explained later.

For esthetic purpose and for easier handling, the four corners of each half portions 13 and 15 are rounded at 33, 35, 37, 39 for front half portion 13, and at 41, 43, 45, 47 for rear half portion 15.

Referring again to the drawings, it will be noted that at the end of the pouch corresponding to opening 3, two shank portions, respectively rear shank portion 49 and front shank portion 51, are provided so as to facilitate tearing off and twisting of pulling tab 5 from pouch 1. More particularly, rear shank portion 49 is a narrow extension of rear half portion 15, while front shank portion 51 is a narrow extension of front half portion 13. In addition, to facilitate the pulling of pulling tab 5 in order to note the promotional material (not shown) placed on insert tab finger 7, front shank portion 51 is provided with a recess 53 which enables a person to pinch pulling tab 5 while also pressing on insert tab 7 in the operation of twisting the pulling tab to remove insert tab 7 from pouch 1.

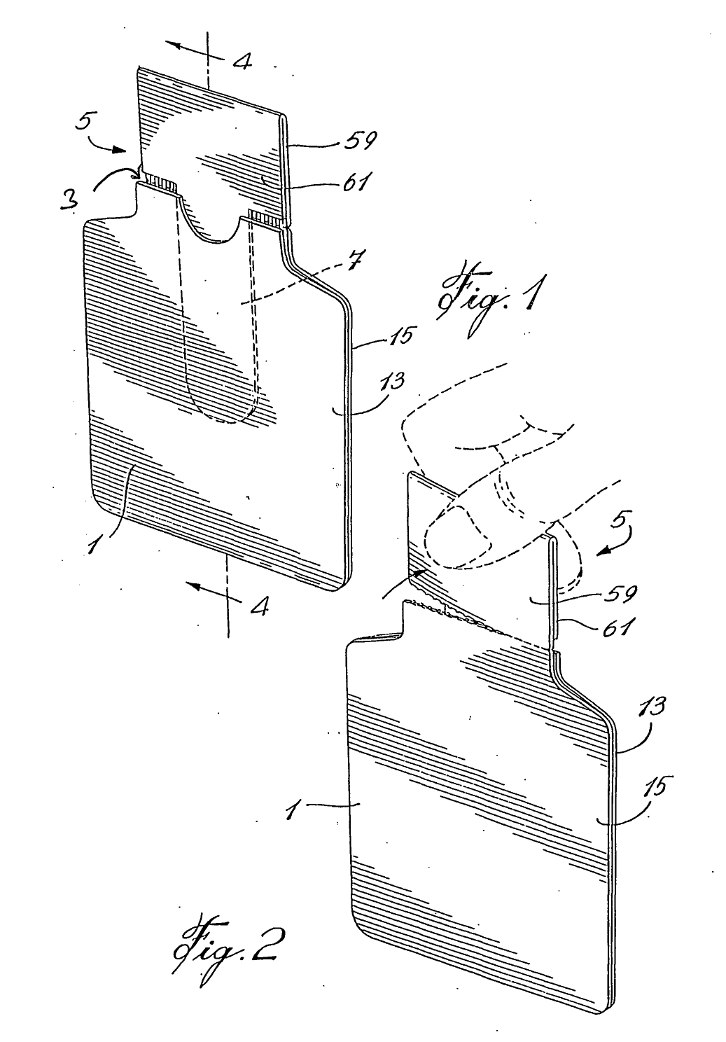

Referring more particularly to FIGS. 1, 4 and 5, a second rectangular sheet 55 extends from rear shank portion 49, as shown particularly in FIG. 5. This sheet is separable from shank portion 49 by means of score line 57 and is divided into first part 59 and second part 61 by means of a folding line 63. In addition, the interior faces of both first part 59 and second part 61 are impregnated with adhesives 65, 67. So, pulling tab 5 really consists of first part 59 and second part 61 which are caused to adhere together face to face through adhesives 65 and 67.

To manufacture promotional card 1, it is merely sufficient to provide a blank as shown in FIG. 5, to apply a promotional material, such as a fragrance, labels, a rub off, a pull apart, or the like, or any combination thereof on insert tab 7 and adhesives 65, 67 respectively on first part 59 and second part 61. Then second part 61 including insert tab 7 is folded at folding line 63 over first part 59 which causes the two parts to adhesively adhere together to constitute pulling tab 5. The next step includes applying an adhesive along the lateral edges of first and second portions 13 and 15 in the form of strips 25, 27, 29 and 31 and folding the first and second portions at folding line 11. This will seal the two portions and will constitute pouch 1 into which insert tab 7 is stored.

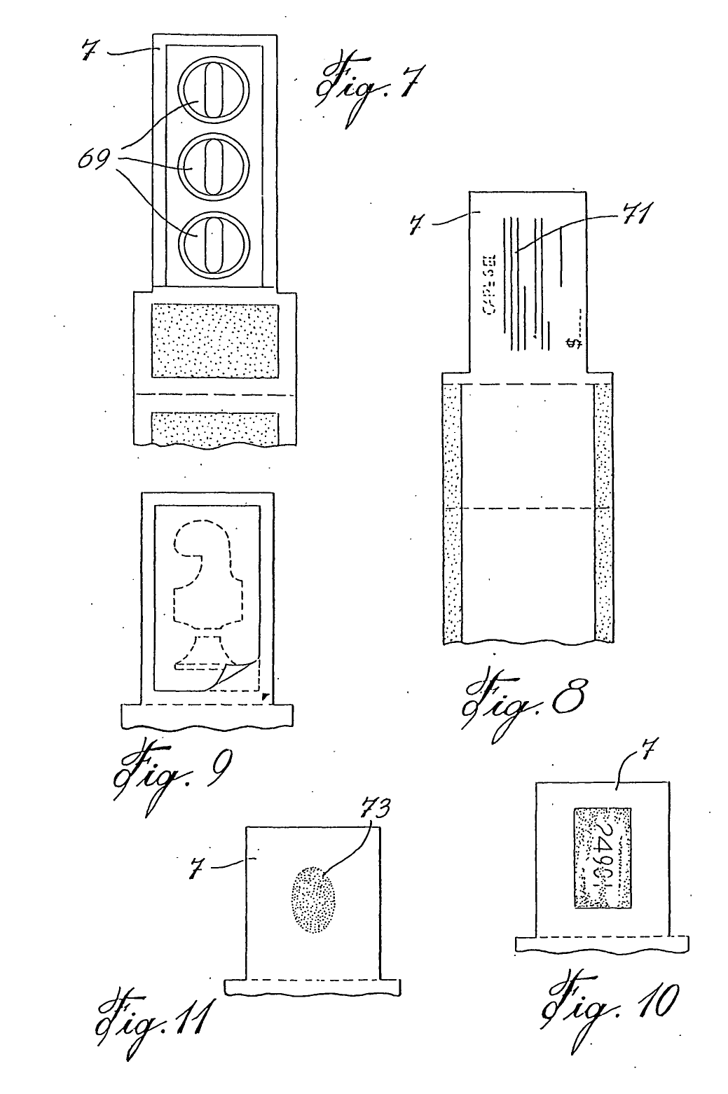

Of course, the promotional card can be used for different promotional purposes. For example, labels 69 as shown in FIG. 7 can be removable disposed on insert tab 7. The labels could be rebate labels or they could be labels to be put on a reply card to be sent to a manufacturer as a rebate, for example. A promotional message 71 as shown in FIG. 8 may also be printed on insert tab 7. The insert tab could contain a powdered fragrance 73 (FIG. 11), or a pull apart 75 (FIG. 9) or a rub off 77 (FIG. 10). These are just examples and it is understood that the invention is not limited thereto.

Of course modifications are possible without departing from the scope and spirit of the invention.

What is claimed is:

1. A promotional card made from a blank of sheet material to contain a promotional material, said fragrance card comprising:
a pouch having an opening;
a pulling tab detachably secured to said pouch adjacent said opening;
an insert tab extending from said pulling tab through said opening into said pouch;
promotional material placed on said insert tab;
so constructed and arranged that in order to take note of said promotional material, said pulling tab is detached from said pouch, the material on said insert tab is noted, after which said insert tab is reinserted into said pouch through said opening to be used for another test.

2. Promotional card according to claim 1, wherein said promotional material comprises at least one label, a rub off, promotional messages, a pull apart, a fragrance, or combinations thereof.

3. Promotional card according to claim 2, wherein said promotional material comprises a fragrance.

4. Promotional card according to claim 1, wherein said pouch comprises a first sheet folded in half along a first folding line, half portions of said first sheet being sealed together along lateral edges thereof while allowing edges opposite said folding line to separate to constitute said opening.

5. Promotional card according to claim 4, wherein said first sheet is rectangular.

6. Promotional card according to claim 3, wherein said rectangular first sheet comprises strips of adhesive along said lateral edges of said half portions, said strips of adhesive being arranged to seal said rectangular sheet material into said pouch, said pouch then being provided with an opening.

7. Promotional card according to claim 3, wherein at an end corresponding to said opening, said pouch comprises a rear shank portion and a front shank portion, said insert tab extending into said pouch between said rear shank portion and said front shank portion.

8. Promotional card according to claim 5, wherein said front shank portion has a recess formed therein to enable a person to pinch said pulling tab while pressing on said insert tab, thereby facilitating pulling and twisting of said pulling tab for taking note of the promotional material.

9. Promotional card according to claim 8, wherein said pulling tab comprises a second sheet folded in half, said second sheet extending from said rear shank portion, and a score line detachably joining said second sheet to said rear shank portion.

10. Promotional card according to claim 9, wherein said second sheet is rectangular.

11. Promotional card according to claim 9, wherein half parts of said second sheet are sealed together by means of an adhesive.

12. Promotional card according to claim 1, which is made or glazed flexible cardboard.

13. Promotional card blank of sheet material comprising a first sheet divided into a first portion and a second portion of similar dimensions by means of a first folding line, a second sheet extending from said first sheet at an end of said second portion, and detachably connected thereto by means of a score line, second sheet being divided into a first part and a second part of similar dimensions by means of a second folding line, and an insert tab extending from said second part at an end thereof.

14. Process for manufacturing a promotional card which comprises providing a promotional card blank according to claim 1, applying promotional material on said insert tab, applying an adhesive on said first part and said second part, folding said second part including said insert tab at said second folding line over said first part, and causing said first part and said second part to adhesively adhere together, applying an adhesive along lateral edges of said first and second portions to form adhesive strips and folding said first portion over said second portion at said first folding line, to seal said first portion against said second portion under conditions to constitute a pouch containing said insert tab.
